(19) United States
(12) Patent Application Publication
(10) Pub. No.: US 2010/0162582 A1
(43) Pub. Date: Jul. 1, 2010

(54) Positioning Device of a Magnetic Ruler

(76) Inventors: Chih-Mao SHIAO, Taichung (TW); Ming-Chih Huang, Taichung (TW)

Correspondence Address: Dr. BANGER SHIA;Patent Office of Bang Shia, 102 Lindencrest Ct., Sugar Land, TX, 77479-5201, US

(21) Appl. No.: 12/345,737

(22) Filed: Dec. 30, 2008

(51) Int. Cl. G01B 7/02

(52) U.S. Cl. 33/708

(57) ABSTRACT

A positioning device of a magnetic ruler is used to position the magnetic ruler onto a guideway, so as to prevent the magnetic ruler from being peeled off the guideway as a result of the reduction of the adhesiveness and to maintain the magnetic induction of the magnetic ruler. Moreover, the restriction assembly can also protect the magnetic ruler and keep it from dust.

### BACKGROUND OF THE INVENTION

1. Field of the Invention

The present invention relates to a positioning device of a magnetic ruler concerning a measurement equipment that uses electrical or magnetic method, such a positioning device can not only prevent the magnetic ruler from being peeled off a guideway as a result of the reduction of the adhesiveness, but also can protect the magnetic ruler and keep it from dust.

2. Description of the Prior Art

Linear guideway is usually used in various machine tables for mechanical processing, for example, as shown in FIG. 1, a conventional linear guideway 11 enables a slide block 12 to perform a smooth linear displacement thereon. On the guideway 11 is provided a magnetic ruler 13 for sensing the position of the slide block 12 with respect to the guideway 11. The guideway 11 is defined with a groove for receiving the magnetic ruler 13. The magnetic ruler 13 is directly stuck to the guideway 11 by adhesive and comprises a magnetic layer and two metal layers stuck to the opposite sides of the magnetic layer. Constituting the configuration of the magnetic ruler 13 itself and positioning the magnetic ruler 13 onto the guideway 11 all require the use of adhesive. However, during operation of the machine table, cutting coolant should be used and a lot of grinding dirties and cutting chips will be produced, which will reduce the adhesiveness of the magnetic ruler 13, and especially both ends of the magnetic ruler 13 will lose their adhesiveness and will be curved up from the guideway 11 as a result of the reduction of the adhesiveness. Similarly, the metal layers will also be separated from the magnetic layer for the same reason. Thereby, the sensing function of the magnetic ruler 13 will be influenced, and even worse, the magnetic ruler 13 can't work as a result of the fact that it will likely to be peeled off the guideway 11.

The present invention has arisen to mitigate and/or obviate the afore-described disadvantages.

### SUMMARY OF THE INVENTION

The primary objective of the present invention is to provide a positioning device of a magnetic ruler which can prevent the magnetic ruler from being peeled off a guideway as a result of the reduction of the adhesiveness and position the magnetic ruler onto the guideway so as to maintain the magnetic induction of the magnetic ruler.

To achieve the objective of the present invention, the positioning device of a magnetic ruler comprises a restriction assembly and two threaded members and is used to position the magnetic ruler onto the guideway. The guideway on which a slide block is movably disposed is provided at its both ends with a threaded hole, respectively. The magnetic ruler is stuck to the guideway and is located opposite the moving path of the slide block. The restriction assembly comprises a cover plate and two lateral plates which are connected to both ends of the cover plate. Each lateral plate is defined with a through hole. The restriction assembly of the positioning device covers the top of the guideway, and the cover plate of the restriction assembly completely covers the magnetic ruler. The lateral plates are located at both ends of the guideway and their through holes are aligned to the threaded holes of the guideway, and the threaded members are threaded through the threaded holes and the through holes into the guideway, so that the restriction assembly is fixed to the guideway to position the magnetic ruler. Thereby, the restriction assembly can position the magnetic ruler onto the guideway, so as to prevent the magnetic ruler from being peeled off the guideway as a result of the reduction of the adhesiveness and to maintain the sensing function of the magnetic ruler. Moreover, the restriction assembly can also protect the magnetic ruler and keep it from dust.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is an illustrative view showing a conventional magnetic ruler being stuck to and peeled off a guideway;

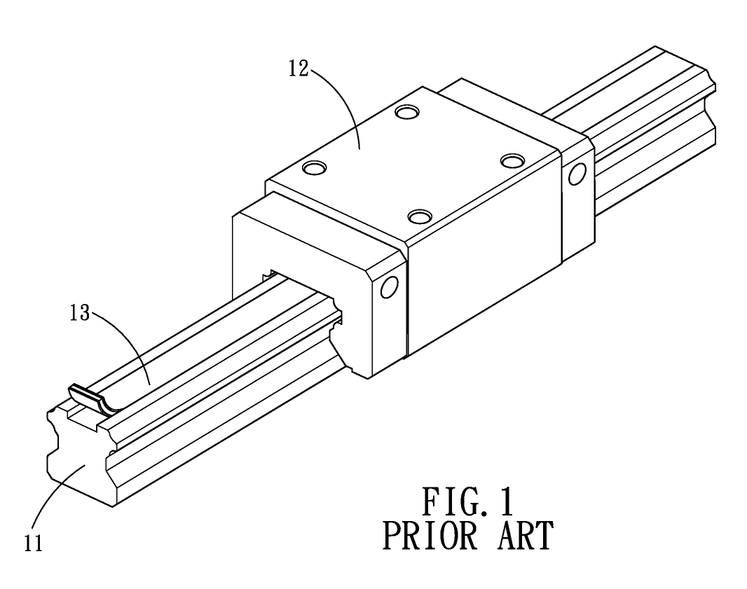

FIG. 2 is an exploded view of a positioning device of a magnetic ruler in accordance with the present invention; and

FIG. 3 is an assembly perspective view of the positioning device of a magnetic ruler in accordance with the present invention.

### DETAILED DESCRIPTION OF THE PREFERRED EMBODIMENTS

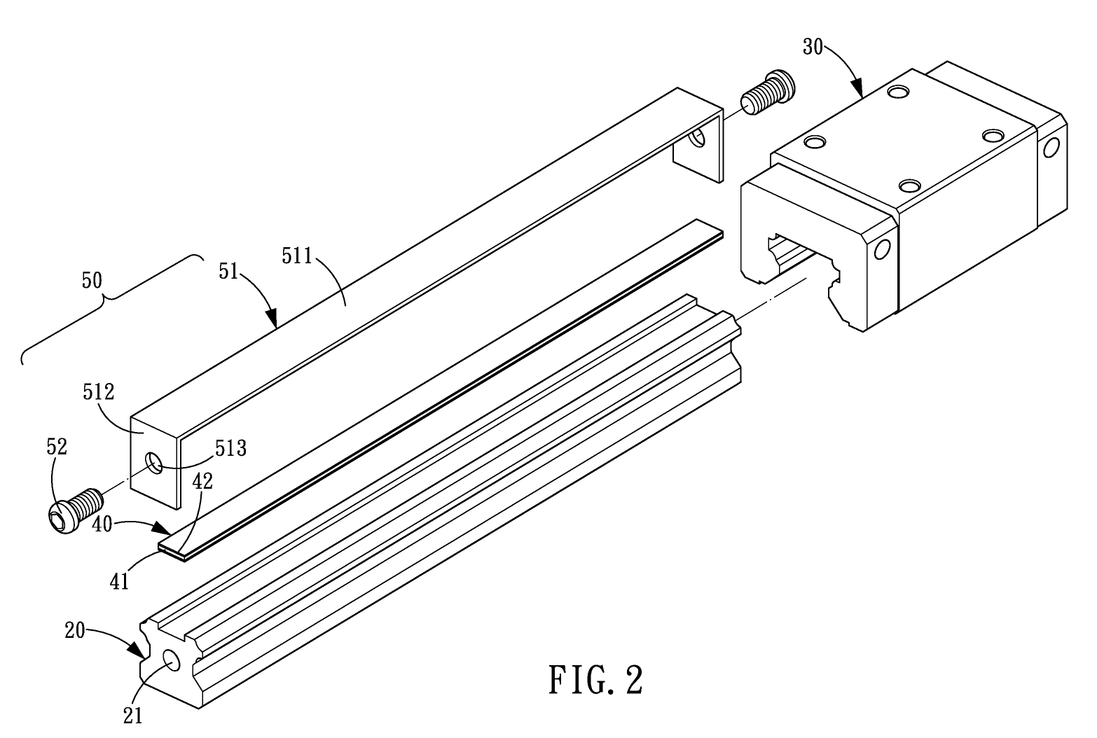

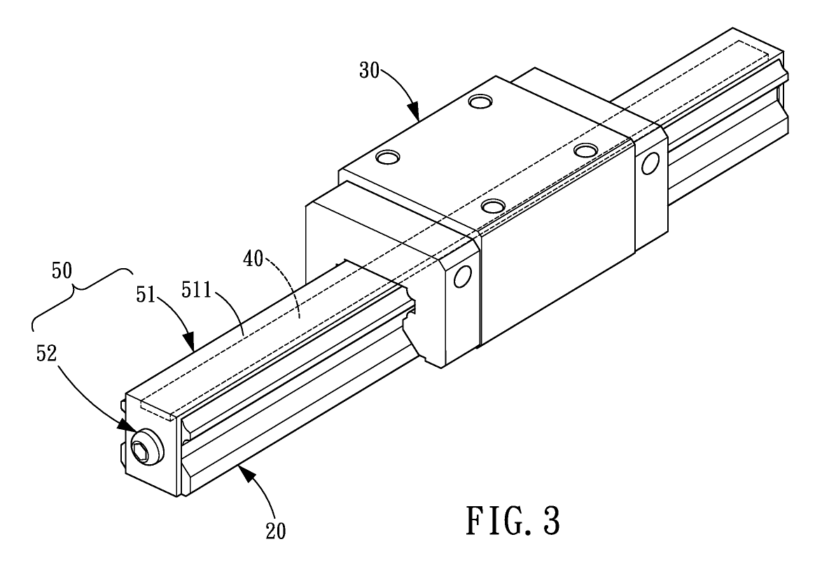

Referring to FIGS. 2 and 3, a positioning device 50 of a magnetic ruler in accordance with the present invention is used to position the magnetic ruler 40 onto a guideway 20.

The guideway 20 on which a slide block 30 is movably disposed is provided at its both ends with a threaded hole 21, respectively.

The magnetic ruler 40 comprises a magnetic layer 41 and two metal layers 42 stuck to the opposite sides of the magnetic layer 41. The magnetic ruler 40 is stuck to the guideway 20 by one of the metal layers 42 and is located opposite the moving path of the slide block 30.

The positioning device 50 comprises a restriction assembly 51 and two threaded members 52. The restriction assembly 51 is formed by folding a metal plate and comprises a cover plate 511 and two lateral plates 512 which are connected to both ends of the cover plate 511. Each lateral plate 512 is defined with a through hole 513. The restriction assembly 51 of the positioning device 50 covers the top of the guideway 20, and the cover plate 511 of the restriction assembly 51 completely covers the magnetic ruler 40. The lateral plates 512 are located at both ends of the guideway 20 and their through holes 513 are aligned to the threaded holes 21 of the guideway 20, and the threaded members 52 are threaded through the threaded holes 21 and the through holes 513 into the guideway 20 to fix the restriction assembly 51 to the guideway 20.

To fix the positioning device 50 to the guideway 20, the magnetic ruler 40 is firstly stuck to the guideway 20 by double-sided adhesive so that it can sense the position of the slide block 30 with respect to the guideway 20, and then the positioning device 50 is mounted on the guideway 20 in such a manner that the cover plate 511 of the restriction assembly 51 of the positioning device 50 covers the magnetic ruler 40, and the through holes 513 of the lateral plates 512 of the restriction assembly 51 are aligned to the threaded holes 21 of the guideway 20. Finally, the threaded members 52 of the positioning device 50 are threaded through the threaded holes 21 and the through holes 513 into the guideway 20, so that the restriction assembly 51 is fixed to the guideway 20 to position the magnetic ruler 40. When the guideway 20 is mounted on a machine table, and the magnetic ruler 40 probably will lose its adhesiveness and will be curved up from the guideway 20 because of the cooling coolant and grinding dirties and chips as mentioned above, the restricting assembly 51 of the positioning device 50 can prevent the magnetic ruler 40 from being peeled off the guideway 20. In addition, since the cover plate 511 of the restriction assembly 51 of the positioning device 50 completely covers the magnetic ruler 40, it can protect the magnetic ruler 40 and keep it from dust. Furthermore, the restriction assembly 51 is made of the metal plate, it can maintain the magnetic induction between the magnetic ruler 40 and the slide block 30. Since the magnetic ruler 40 itself is made by adhering two metal layers 42 to the magnetic layer 41 in such a manner that it is likely to be damaged as a result of the reduction of the adhesiveness, the positioning device 50 can also prevent the magnetic ruler 40 from being curved up from the guideway 20. Therefore, the positioning device 50 can not only position the magnetic ruler 40 onto the guideway 20 reliably, but also strengthen the structure of the magnetic ruler 40. Moreover, since the positioning device 50 is threaded into the guideway 20, it is convenient to assemble.

While we have shown and described various embodiments in accordance with the present invention, it should be clear to those skilled in the art that further embodiments may be made without departing from the scope of the present invention.

What is claimed is:

1. A positioning device of a magnetic ruler, comprising a restriction assembly and two threaded members and being used to position the magnetic ruler onto a guideway, wherein:
the guideway on which a slide block is movably disposed is provided at its both ends with a threaded hole, respectively;
the magnetic ruler is stuck to the guideway and is located opposite the moving path of the slide block; and
the restriction assembly comprises a cover plate and two lateral plates connected to both ends of the cover plate, each lateral plate is defined with a through hole, the restriction assembly covers a top of the guideway, the cover plate of the restriction assembly completely covers the magnetic ruler, the lateral plates of the restriction assembly are located at both ends of the guideway, the through holes of the lateral plates are aligned to the threaded holes of the guideway, the threaded members are threaded through the through holes and the threaded holes into the guideway, so that the restriction assembly is fixed to the guideway to position the magnetic ruler.

2. The positioning device of a magnetic ruler as claimed in claim 1, wherein the restriction assembly of the positioning device is formed by folding a metal plate.

3. The positioning device of a magnetic ruler as claimed in claim 1, wherein the magnetic ruler comprises a magnetic layer and two metal layers stuck to opposite sides of the magnetic layer, and the magnetic ruler is stuck to the guideway by one of the metal layers.
